(19) United States
(12) Patent Application Publication
(10) Pub. No.: US 2006/0006559 A1
(43) Pub. Date: Jan. 12, 2006

(54) Light guide plate mold and method for manufacturing the same

(75) Inventors: Takeo Nakagawa, Tokyo (JP); Fumio Nakamura, Tokyo (JP); Norio Goto, Tokyo (JP); Jun-Qi Li, Shenzhen (CN)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(73) Assignee: HON HAI Precision Industry CO., LTD., Tu-Cheng City (TW)

(21) Appl. No.: 11/168,076

(22) Filed: Jun. 28, 2005

(30) Foreign Application Priority Data
Jul. 9, 2004 (CN) 200410028069.1

(51) Int. Cl. B29D 11/00; B29C 33/40

(52) U.S. Cl. 264/2.5; 264/219; 425/808

(57) ABSTRACT

A light guide plate mold (100) includes a surface (103) and a plurality of micro structures formed at the surface according to a predetermined pattern. Some micro structures have angular cross-sections and other micro structures have arcuate cross-sections. The light guide plate mold can manufacture light guide plates with simple structures, and the light guide plates can obtain emission light beams with good uniformity and brightness. Therefore, the manufactured light guide plates can be advantageously applied in back light systems of liquid crystal display devices. Furthermore, a method for manufacturing the light guide plate mold is also provided, the method has a relatively low cost, and can be executed with high speed and precision.

### BACKGROUND

The invention relates generally to a light guide plate mold for manufacturing light guide plates typically used in back light systems of liquid crystal display devices, and a method for manufacturing the light guide plate mold.

Back light systems are used in liquid crystal display devices for converting linear light sources such as cold cathode ray tubes or point light sources such as light emitting diodes into area light sources having high uniformity and brightness.

Referring to FIGS. 12 and 13, a conventional back light system includes a light guide plate 2, a cold cathode ray tube 1 disposed beside a light introduction surface of the light guide plate 2, a reflector 1A disposed essentially around three sides of the cold cathode ray tube 1, a plurality of micro structures 3 formed on a light reflection surface of the light guide plate 2, a lower diffusion plate 4 installed upon a light emitting surface of the light guide plate 2, a lower prism sheet 5 and an upper prism sheet 6 installed upon the lower diffusion plate 4 in turn, and an upper diffusion plate 7 installed upon the upper prism sheet 6.

As indicated in FIG. 12, when a light beam emitted from the cold cathode ray tube 1 is introduced into the light guide plate 2 and travels therein, the micro structures 3 can break up what would otherwise be a total reflection condition of the light beam. This ensures that most of the light beam can pass through the light emitting surface of the light guide plate 2. Furthermore, the lower diffusion plate 4 and the upper diffusion plate 7 can diffuse the emitted light beam, and the upper prism sheet 6 and the lower prism sheet 5 can adjust a direction of the emitted light beam, thereby ensuring that the emitted light beam finally travels along a path normal to the light guide plate 2. This ensures that the emitted light beam has good uniformity and brightness.

The micro structures 3 can be circular, dome-shaped, elliptic, or semicircular. Sizes of the micro structures 3 are in the range from a scale of micrometers to a scale of millimeters. Conventional methods for forming the micro structures 3 include screen printing, mechanical treatment, and lithographic galvanoformung abformung (LIGA).

Screen printing is performed by printing ink or resin on a reflection surface of the light guide plate 2 through a screen. One shortcoming of screen printing is that a size of every micro structure 3 must be greater than 300 micrometers. In addition, the shapes of the micro structures 3 must in general be uniform.

A typical mechanical treatment process is performed as follows. Firstly, a female die and a mold are formed. Secondly, the light guide plate 2 with the micro structures 3 is formed by injection molding or press molding using the female die and mold. Shapes of the micro structures 3 can vary. However, sizes of the micro structures 3 must be greater than several tens of micrometers.

LIGA is performed as follows. Firstly, a photo resist is coated on a base plate. Secondly, the photo resist is exposed and developed to form structures corresponding to the micro structures 3. Thirdly, a mold is formed by means of galvanoformung abformung (GA). Finally, the light guide plate 2 with the micro structures 3 is formed by injection molding or press molding using the mold. LIGA is a relatively complex process having a high cost.

In general, the micro structures 3 formed by the above-described conventional methods must have a large size and/or cannot have various different shapes. Therefore the conventional light guide plate 2 needs to be combined with the diffusion plates 4, 7 and the prism sheets 5, 6 in order to obtain emission of light beams with good uniformity and brightness. The assembly comprising the light guide plate 2 is rather complex, and the cost of producing the assembly is high.

What is needed, therefore, is a light guide plate mold that can manufacture light guide plates having relatively simple structures, such that the light guide plates can provide emission of light beams with good uniformity and brightness without the need for added light enhancing structures.

What is also needed is a method for manufacturing the above-described light guide plate mold, the method having a low cost, and the micro structures formed by the method having a small size and varying in shape.

### SUMMARY

In one embodiment, a light guide plate mold includes a surface and a plurality of micro structures formed on the surface according to a predetermined pattern. In the embodiment, the micro structures are recesses, some of them have angular cross-sections and the others have arcuate cross-sections. The light guide plate mold can be used to manufacture light guide plates by means of injection molding, hot press, rolling or coating. Each manufactured light guide plate has micro structures corresponding to the micro structures of the light guide plate mold. The micro structures are recesses and arranged on a surface of the light guide plate according to the predetermined pattern. Some recesses have angular cross-sections and can determine a direction of emission of light beams, and the other recesses have arcuate cross-sections and can determine the degree of uniformity of the emitted light beams. Therefore, the light beams can be emitted from a predetermined region of the light guide plate, and this ensures the emission light beams with improved uniformity and brightness.

In another embodiment, a method for manufacturing the light guide plate mold includes the steps of:
(a) providing an imprinter having a plurality of press heads with a plurality of shapes;
(b) providing a light guide plate mold preform;
(c) driving the imprinter with a first press head and forming a plurality of first recesses with a first shape in a first predetermined area of the light guide plate mold preform;
(d) driving the imprinter with another press head and forming a plurality of other recesses with another shape in another predetermined area of the light guide plate mold preform; and
(e) repeating step (d) a desired number of times.

The inventive light guide plate mold can manufacture light guide plates with micro structures that can adjust the direction and uniformity of light beams. Therefore, the manufactured light guide plates do not need to have diffusion plates or prism sheets added thereto. That is, the light guide plates have simple structures. Furthermore, the recesses enable the light guide plate to achieve emission of light beams with improved uniformity and brightness. Therefore, the light guide plate can be advantageously applied in back light systems of liquid crystal display devices.

The method for manufacturing the light guide plate mold is simple, and yields plural recesses with desired plural shapes and small sizes in the mold. The method has a relatively low cost, and can be executed with high speed and precision.

Other advantages and novel features will become more apparent from the following detailed description of preferred embodiments when taken in conjunction with the accompanying drawings, in which:

### BRIEF DESCRIPTION OF THE DRAWINGS

FIG. 1 is an isometric view of a press head that can be used in a preferred method according to one embodiment of the present invention;

FIG. 2 is an isometric, cut-away view of a light guide plate mold preform during manufacturing according to the preferred method, showing the light guide plate mold preform with a recess formed therein by using the press head of FIG. 1;

FIG. 3 is an isometric view of another press head that can be used in the preferred method;

FIG. 4 is an isometric view of still another press head that can be used in the preferred method;

FIG. 5 is an isometric view of yet another press head that can be used in the preferred method;

FIG. 6 is similar to FIG. 2, but showing the whole light guide plate mold preform, and a plurality of recesses formed in the light guide plate mold preform, the recesses cooperatively defining a substantially linear groove;

FIG. 7 is a cross-sectional view taken along line VII-VII of FIG. 6;

FIG. 8 is a schematic, isometric view of a light guide plate mold made according to the preferred method, the light guide plate mold having a plurality of recesses, the recesses cooperatively defining grooves arranged in a pattern;

FIG. 9 is similar to FIG. 8, but showing a light guide plate mold having grooves arranged in a different pattern;

FIG. 10 is similar to FIGS. 8 and 9, but showing a light guide plate mold having grooves arranged in another different pattern;

FIG. 11 is a flow chart of the preferred method for manufacturing a light guide plate mold;

FIG. 12 is a schematic, exploded side view of a conventional back light system, showing essential optical paths thereof; and

FIG. 13 is a simplified, exploded, isometric view of a light guide plate assembly of the back light system of FIG. 12.

### DETAILED DESCRIPTION OF PREFERRED EMBODIMENTS

Reference will now be made to the drawings to describe embodiments of the present invention in detail.

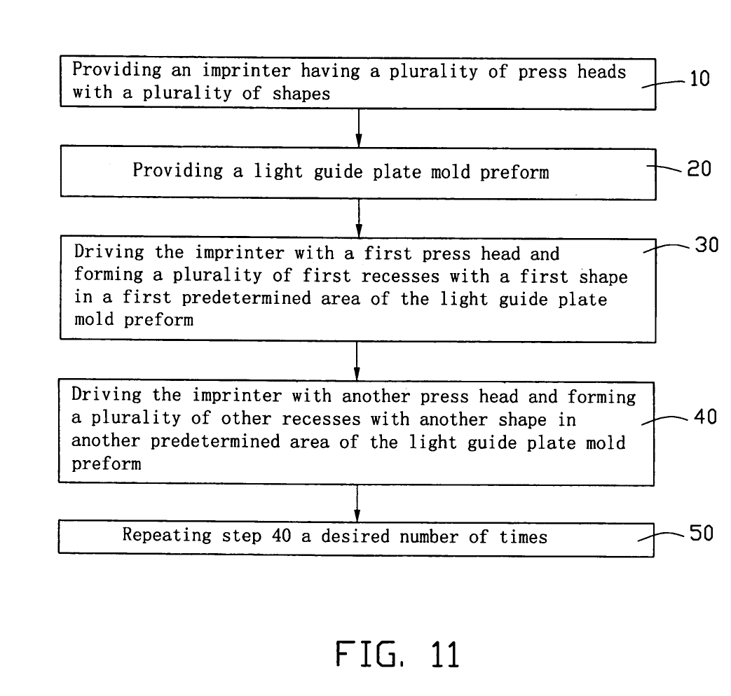

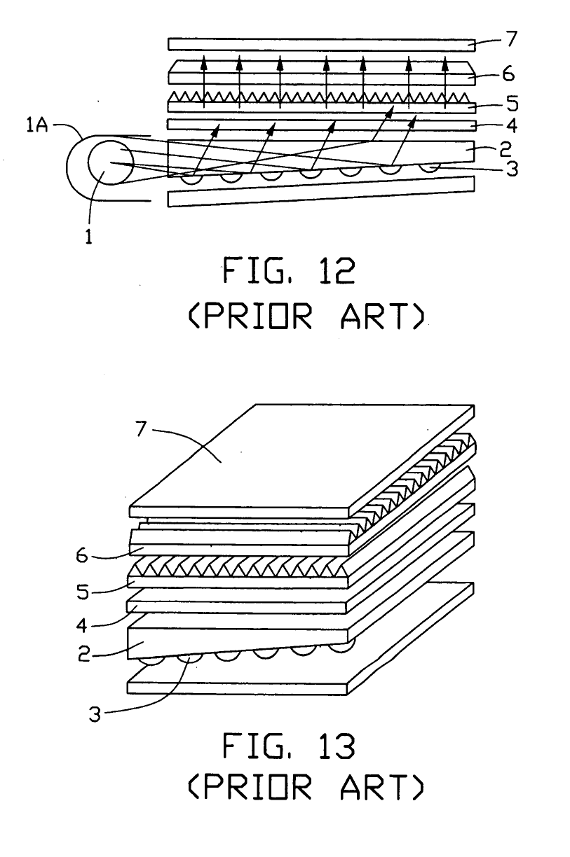

Referring to FIG. 11, a preferred method for manufacturing a light guide plate mold in accordance with one embodiment of the present invention comprises the steps of:
(10) providing an imprinter having a plurality of press heads with a plurality of shapes;
(20) providing a light guide plate mold preform;
(30) driving the imprinter with a first press head and forming a plurality of first recesses with a first shape in a first predetermined area of the light guide plate mold preform;
(40) driving the imprinter with another press head and forming a plurality of other recesses with another shape in another predetermined area of the light guide plate mold preform; and
(50) repeating step (40) a desired number of times, thereby forming a light guide plate mold having different kinds of recesses with different shapes in the predetermined areas.

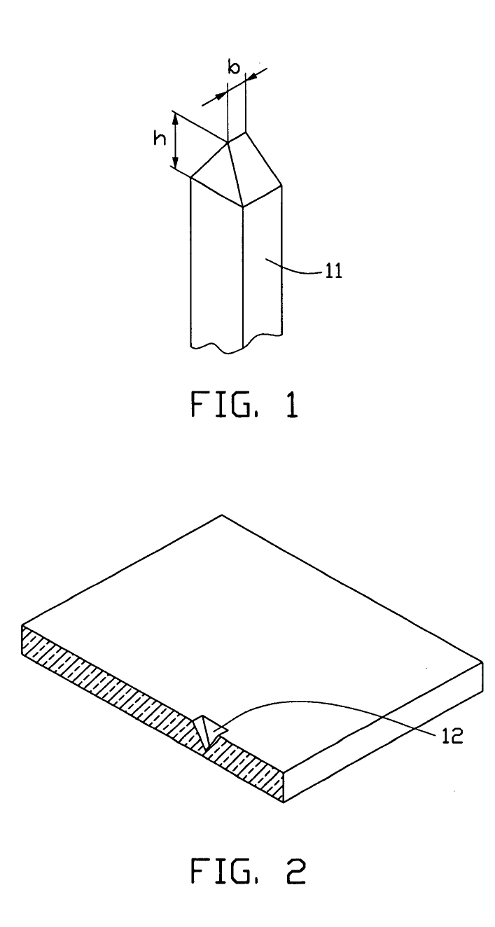

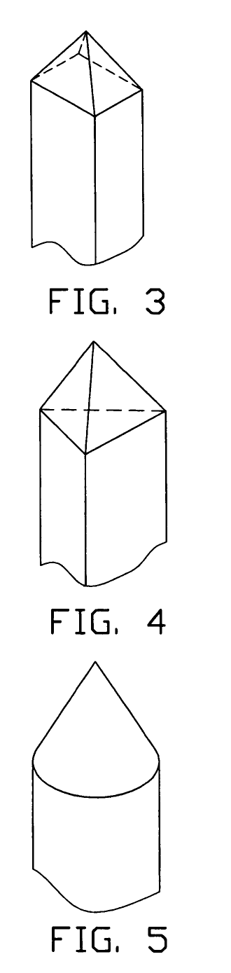

In step (10), the press heads are generally made of a hard material, such as diamond. The press heads can have a variety of different tapered forms, such as being pyramidal, substantially pyramidal, or conical, as shown in FIGS. 1, 3, 4 and 5. Furthermore, the press heads can for example be hemispherical, rounded, or columnar. Recesses defining V-shaped or angular cross-sections can be formed by tapered press heads, recesses defining generally rectangular cross-sections can be formed by columnar press heads, and recesses defining arcuate cross-sections can be formed by hemispherical or rounded press heads. The arcuate cross-sections may for example be semicircular, elliptical, or bowl-shaped. In a light guide plate manufactured by a duly formed light guide plate mold, recesses of the light guide plate defining angular cross-sections can determine a direction of emission of light beams from the light guide plate. This helps ensures that light beams are emitted from a predetermined region of the light guide plate. In contrast, recesses of the light guide plate defining arcuate cross-sections can determine the degree of uniformity of light beams emitted from the light guide plate.

As shown in FIG. 1, a press head 11 has an end width b and an end height h. The end width b and end height h are both less than 5 micrometers, which ensures that recesses formed by the press head 11 are small. Therefore, a liquid crystal display device incorporating a light guide plate manufactured by the light guide plate mold can have good imaging quality.

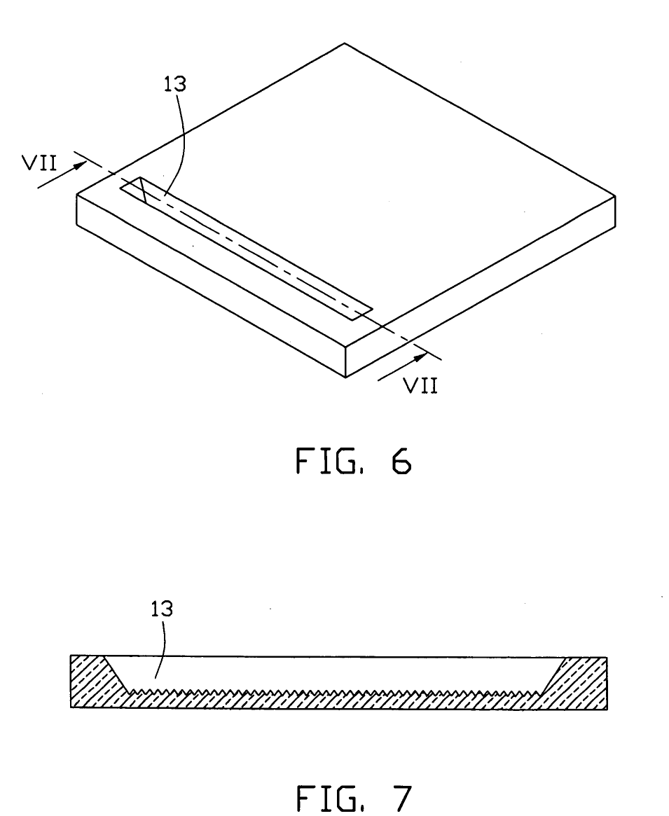

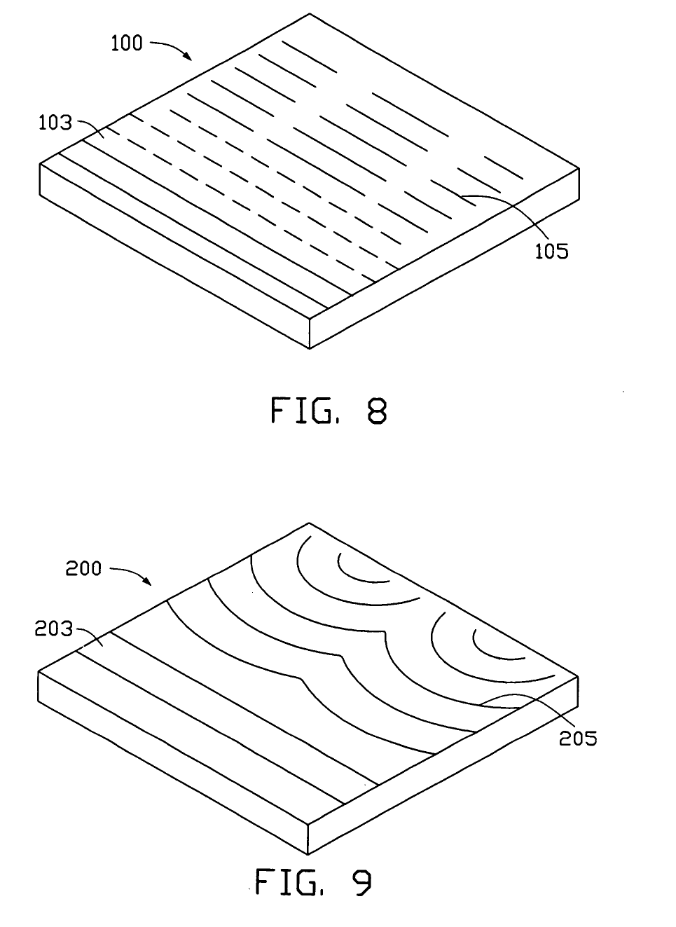

In step (20), the light guide plate mold preform is generally made of nickel or nickel alloy. Preferably, a guiding pattern is preformed on at least one major surface of the light guide plate mold perform, so that subsequently recesses are formed in the light guide plate mold perform according to the guiding pattern. In step (30), a linear motor or piezoelectric material is used for driving the imprinter. As shown in FIG. 2, a recess 12 is formed in the light guide plate mold preform by impressing with the press head 11. Preferably, an electronic controlling device is installed in the imprinter. The electronic controlling device controls a direction and depth of impression, and a pitch or distance between successive impressions. If a pitch is relatively small, a plurality of recesses 12 can cooperatively define a substantially linear groove or a substantially curvilinear groove. Either of such grooves can be either continuous or (in effect) discontinuous. FIGS. 6 and 7 show a continuous linear groove 13. In step (40), selection of each of the press heads is controlled by the electronic controlling device. Upon completion of step (50), the different kinds of recesses are located at the surface of the light guide plate mold according to a predetermined desired pattern.

Various different light guide plate molds that can be manufactured by the preferred method are shown in FIGS. 8, 9 and 10. As shown in FIG. 8, a light guide plate mold 100 includes a surface 103, and a plurality of recesses defining arcuate cross-sections and a plurality of recesses defining angular cross-sections formed at the surface 103. The recesses communicate with one another to define a plurality of substantially linear grooves 105. Some of the grooves 105 are continuous, and some are discontinuous. A light guide plate manufactured by using the light guide plate mold 100 has a corresponding pattern of grooves.

As shown in FIG. 9, a light guide plate mold 200 includes a surface 203, and a plurality of recesses defining arcuate cross-sections and a plurality of recesses defining angular cross-sections formed at the surface 203. The recesses communicate with one another to define a plurality of substantially curvilinear grooves 205, and a plurality of substantially linear grooves (not labeled). All of the grooves are continuous. A light guide plate manufactured by using the light guide plate mold 200 has a corresponding pattern of grooves.

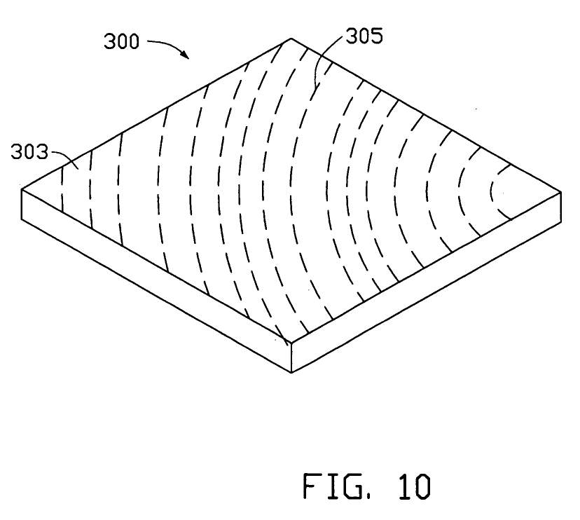

As shown in FIG. 10, a light guide plate mold 300 includes a surface 303, and a plurality of recesses defining arcuate cross-sections and a plurality of recesses defining angular cross-sections formed at the surface 303. The recesses communicate with one another to define a plurality of substantially curvilinear grooves 305. All of the grooves are discontinuous. A light guide plate manufactured by using the light guide plate mold 300 has a corresponding pattern of grooves.

The light guide plate molds of the above-described embodiments can manufacture light guide plates with recesses that can adjust the direction and uniformity of light beams. Therefore, the manufactured light guide plates do not need to have any diffusion plates or prism sheets added thereto. That is, the light guide plates have simple structures. Furthermore, the recesses enable the light guide plates to achieve emission of light beams with improved uniformity and brightness. The light guide plates are advantageously applied in back light systems of liquid crystal display devices.

In addition, the preferred method for manufacturing the light guide plate mold is simple, and yields plural recesses with desired plural shapes and small sizes in the mold. The method has a relatively low cost, and can be executed with high speed and precision.

It is noted that, in addition to the various embodiments described above, the recesses defining arcuate cross-sections and recesses defining angular cross-sections can be configured to communicate with one another and cooperatively form any of various other desired patterns of grooves.

It is to be understood that the above-described embodiments are intended to illustrate rather than limit the invention. Variations may be made to the embodiments without departing from the spirit of the invention as claimed. The embodiments illustrate the scope of the invention but do not restrict the scope of the invention.

We claim:

1. A light guide plate mold comprising:
a surface; and
a plurality of recesses defining arcuate cross-sections and a plurality of recesses defining angular cross-sections formed at the surface according to a predetermined pattern.

2. The light guide plate mold as claimed in claim 1, wherein the arcuate cross-sections are selected from the group consisting of semicircular cross-sections, elliptical cross-sections, and bowl-shaped cross-sections.

3. The light guide plate mold as claimed in claim 1, wherein the angular cross-sections are selected from the group consisting of V-shaped cross-sections and generally rectangular cross-sections.

4. The light guide plate mold as claimed in claim 1, wherein at least two of the recesses communicate with each other to cooperatively form at least one linear groove.

5. The light guide plate mold as claimed in claim 1, wherein at least two of the recesses communicate with each other to cooperatively form at least one curvilinear groove.

6. A method for manufacturing a light guide plate mold, the method comprising the steps of:
(a) providing an imprinter having a plurality of press heads with a plurality of shapes;
(b) providing a light guide plate mold preform;
(c) driving the imprinter with a first press head and forming one or more first recesses with a first shape in a first predetermined area of the light guide plate mold preform; and
(d) driving the imprinter with another press head and forming one or more other recesses with another shape in another predetermined area of the light guide plate mold preform.

7. The method as claimed in claim 6, further comprising repeating step (d) a desired number of times.

8. The method as claimed in claim 6, wherein forms of the press heads are selected from the group consisting of tapered forms, hemispherical forms, rounded forms, and columnar forms.

9. The method as claimed in claim 6, wherein in step (c) a linear motor or piezoelectric material is used for driving the imprinter.

10. The method as claimed in claim 6, wherein an electronic controlling device is used with the imprinter for controlling a selection of each press head, a direction and depth of impression, and a pitch or distance between successive impressions using the same press head.

11. The method as claimed in claim 6, wherein a guiding pattern is preformed on the surface of the light guide plate mold perform before step (c), and the recesses are formed according to the guiding pattern.

12. A method for manufacturing a mold with micro-structures formed thereon, the method comprising the steps of:
preparing at least two groups of press heads shaped differently from each other and corresponding to said micro-structures;
preparing a preform to be manufactured as said mold;
imprinting a first portion of said micro-structures onto said preform by means of a first group of said at least two groups of press heads; and
repeating said imprinting step to form a second portion of said micro-structures onto said preform by means of a second group of said at least two groups of press heads so as to complete said mold with said micro-structure.

13. The method as claimed in claim 12, wherein at least one group of said first and second groups of press heads is formed with an imprinter so as to implement said imprinting step by driving of said imprinter.
